(19) United States
(12) Patent Application Publication
(10) Pub. No.: US 2024/0378567 A1
(43) Pub. Date: Nov. 14, 2024

(54) DETECTING AND PRIORITIZING ELECTRONIC COMMUNICATIONS BASED ON USER CALENDAR EVENTS

(71) Applicant: Cisco Technology, Inc., San Jose, CA (US)

(72) Inventors: Pedro Jesus Garcia Chavez, Mexico City (MX); Elena Gribanova, Dublin, CA (US); Valentin Filippov, Maple (CA); David C. White, JR., St. Petersburg, FL (US); Wei Yan, Oakland, CA (US)

(21) Appl. No.: 18/315,680

(22) Filed: May 11, 2023

(51) Int. Cl. G06Q 10/1093

(52) U.S. Cl. CPC G06Q 10/1095

(57) ABSTRACT

A method, computer system, and computer program product are provided for prioritizing communications relating to a meeting. One or more unread or unanswered communications received by a user are analyzed with respect to a plurality of calendar events of the user. One or more high-priority communications in the one or more unread or unanswered communications are identified that relate to a particular calendar event of the plurality of calendar events, based on relevance and urgency with respect to the particular calendar event. Instructions are transmitted to a user device of the user to cause the user device to present an alert to the user regarding the one or more high-priority communications.

### TECHNICAL FIELD

The present disclosure relates generally to electronic communications, and more specifically, to detecting and prioritizing electronic communications in a manner that is based on user calendar events.

### BACKGROUND

Electronic communications, such as emails, chat messages, and telephone calls, have revolutionized the way people work and collaborate, enabling users to easily connect with colleagues and schedule meetings through digital calendars and messaging platforms. However, despite the numerous benefits of these tools, users may continue to struggle with managing their schedules effectively, often missing important messages related to their scheduled meetings. This lack of preparedness can lead to missed deadlines, decreased productivity, and missed opportunities. For example, users may be inundated with a constant stream of messages, making it difficult to distinguish between important information and low-priority messages. Furthermore, the disjointed nature of existing communication tools exacerbates the problem, as users need to switch between multiple applications or interfaces to manage their calendars and communicate with meeting participants. This can lead to missed messages, forgotten appointments, and decreased productivity.

### BRIEF DESCRIPTION OF THE DRAWINGS

FIG. 1 is a block diagram of a computing environment in which communications relating to a meeting may be prioritized, according to an example embodiment.

FIG. 2A is a diagram of a graphical user interface for presenting an alert to a user, according to an example embodiment.

FIG. 2B is a diagram of a graphical user interface for presenting an alert to a user, according to an example embodiment.

FIG. 3 is a flow chart of a method of alerting a user to high-priority communications, according to an example embodiment.

FIG. 4 is a flow chart of a method of identifying high-priority communications, according to an example embodiment.

FIG. 5 is a flow chart of a method of training and applying a machine learning model, according to an example embodiment.

FIG. 6 is a block diagram of a device that may be configured to perform operations to enable prioritizing of network traffic, as presented herein.

### DETAILED DESCRIPTION

### Overview

According to one embodiment, techniques are provided for prioritizing communications relating to a meeting. One or more unread or unanswered communications received by a user are analyzed with respect to a plurality of calendar events of the user. One or more high-priority communications in the one or more unread or unanswered communications are identified that relate to a particular calendar event of the plurality of calendar events, based on relevance and urgency with respect to the particular calendar event. Instructions are transmitted to a user device of the user to cause the user device to present an alert to the user regarding the one or more high-priority communications.

### Example Embodiments

Present embodiments relate to electronic communications, and more specifically, to detecting and prioritizing electronic communications in a manner that is based on user calendar events. In the era of remote/hybrid work, electronic communication (e.g., chat messaging, e-mail, etc.) has become an increasingly important tool for coworkers to stay connected and collaborate in real-time. However, as the use of electronic communication has increased, it has become increasingly difficult to manage multiple conversation threads, leading to confusion and decreased productivity. The problem of managing multiple conversation threads is exacerbated when systems do not provide any features for detecting important chat messages based on upcoming meetings. In such scenarios, it can become cumbersome for team members to keep track of important messages and prioritize their work. This can lead to unpreparedness, missed deadlines, misunderstandings, and/or reduced efficiency.

To address this problem, the embodiments presented herein provide an improved approach that can prioritize particular messages which are particularly important to a user's upcoming calendar meetings. In particular, a user's unread and/or unanswered messages are analyzed in combination with the user's calendar in order to identify details that the user may have missed and that are important for an upcoming scheduled event. High-priority messages can be automatically identified based on the relevance of each message to a calendar event and/or the proximity in time of the calendar event (which may indicate that a message urgently requires a user's attention). Thus, present embodiments improve the technical field of electronic communication by highlighting important messages that a user may have missed, providing the practical application of increasing user productivity and improved communications.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description and appended claims, or may be learned by the practice of embodiments as set forth hereinafter.

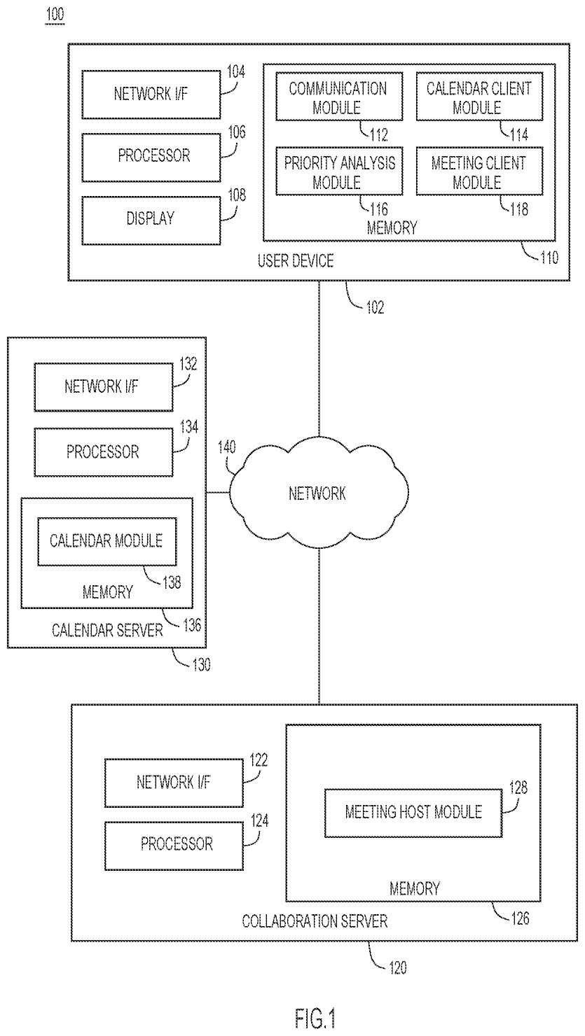

Embodiments will now be described in detail with reference to the Figures. Reference is now made to FIG. 1. FIG. 1 is a block diagram in which a computing environment 100 is shown for prioritizing communications relating to a meeting, according to an example embodiment. As depicted, computing environment 100 includes a user device 102, a collaboration server 120, and a calendar server 130 that are in communication via a network 140. It is to be understood that the functional division among components have been chosen for purposes of explaining various embodiments and is not to be construed as a limiting example.

User device 102 includes a network interface (I/F) 204, at least one processor (computer processor) 206, a display 108, and memory 110, which stores instructions for a communication module 112, a calendar client module 114, a priority analysis module 116, and a meeting client module 118. In various embodiments, user device 102 may include a rack-mounted server, laptop, desktop, smartphone, tablet, or any other programmable electronic device capable of executing computer readable program instructions. Network interface 104 enables components of user device 102 to send and receive data over a network, such as network 140. There may be multiple user devices 102 as part of the computing environment 100. For simplicity, a single user device 102 is shown.

In general, user device 102 may perform operations relating to the presentation of communications to a user, and in particular, prioritizing communications that are deemed of importance in accordance with the embodiments presented herein. Display 108 may include any electronic device capable of presenting information in a visual form. For example, display 108 may be a liquid crystal display (LCD), a cathode ray tube (CRT) display, a light-emitting diode (LED) display, an electronic ink display, and the like.

Communication module 112, calendar client module 114, priority analysis module 116, and/or meeting client module 118 may include one or more modules or units to perform various functions of the embodiments described below. Communication module 112, calendar client module 114, priority analysis module 116, and/or meeting client module 118 may be implemented by any combination of any quantity of software and/or hardware modules or units, and may reside within memory 110 of user device 102 for execution by a processor, such as processor 106.

Communication module 112 enables a user of user device 102 to engage in electronic communications with other individuals. In various embodiments, communication module 112 may include a telephony client (e.g., an audio-based communication client), an e-mail client, a chat client, a short messenger service (SMS) client, or any other client for communicating with others. Communication module 112 may present communications to a user via a graphical user interface that is displayed at display 108 of user device 102. Thus, a user may engage with communication module 112 to read or listen to communications, and can respond to communications.

In some embodiments, communication module 112 presents alerts regarding communications, including alerts when a communication is received and/or subsequent alerts to remind a user of a communication (e.g., an unread or unanswered communication). The alerts can include audio-based alerts, visual alerts presented by a graphical user interface, haptic feedback alerts, and any other form of alert that user device 102 is capable of generating in order to draw a user's attention. Communication module 112 may generate reminder alerts for a communication that is determined to be a high-priority communication (e.g., by priority analysis module 116). In some embodiments, the type(s) of alerts that are used for an incoming communication are different from the type(s) of alerts that are used for a reminder of a high-priority communication, thereby increasing the likelihood of capturing the user's attention. For example, an alert for an incoming communication may be a user interface element that is presented for a short duration and then disappears, whereas a reminder alert may be presented over other user interface elements for an unlimited duration until the user interacts with the reminder alert or otherwise acknowledges the corresponding communication. In some embodiments, the alert can be reclassified (e.g., marked as an outstanding item) or the alert may be removed, de-prioritized, or otherwise reverted when the event related to the alert has already occurred. As another example, an alert for a high-priority communication may utilize a different mode of alerting than that of an incoming communication (e.g., an audio alert vs. a visual alert). As yet another example, an alert for a high-priority communication may alert the user via a combination of different modes of alert (e.g., a combination of an audio alert and visual alert, etc.).

Calendar client module 114 may include any client that manages a user's schedule in order to remind a user of upcoming events, store details relating to those events (e.g., a name or topic for a meeting, a hyperlink or phone number to join a meeting), and/or to share a user's schedule with others. In some embodiments, calendar client module 114 interacts with a calendar server (e.g., calendar server 130) to retrieve and display information about scheduled appointments, including the time, date, location, and/or attendees of each appointment. Calendar client module 114 may integrate with other software, such as an email client or other communication client (which can be a component of communication module 112). By interacting with a server, calendar client module 114 can provide the ability to manage shared calendars or to schedule meetings with multiple attendees.

Priority analysis module 116 may analyze data relating to a user's communications in combination with the user's calendar data in order to identify high-priority communications that have been received by a user. As such, priority analysis module 116 may obtain or receive the data from communication module 112, calendar client module 114, calendar module 138 of calendar server 130, and/or from any other source where the user data may be stored. Priority analysis module 116 may identify high-priority communications by identifying calendar events that are related to the user's communications. In some embodiments, priority analysis module 116 analyzes a subset of the user's received communications that include unread communications and/or unanswered communications, which may indicate that a user does not knowledge of the content of the communication, or that the user is not adequately prepared for the upcoming calendar event to which the communication relates.

Priority analysis module 116 may identify high-priority communications based on an urgency and a relevance of each communication. A communication's urgency may be determined based on a current time compared to a time of a calendar event. In particular, as the current time draws nearer to the calendar event, the urgency increases. For example, if a communication relates to a calendar event that is two days in the future, that communication is less urgent than a communication that relates to a calendar event that is two hours in the future. Thus, unread and/or unanswered communications increase in urgency as a calendar event approaches. Urgency can be determined via an urgency score that quantitatively describes urgency by assigning values based on the proximity of a calendar event to an unread or unanswered communication. For example, higher numerical values may indicate higher urgency, and assigned urgency values may increase as proximity to the upcoming calendar event increases.

Priority analysis module 116 may determine the relevance of each communication by analyzing content of the communication in combination with calendar event data. In some embodiments, priority analysis module 116 performs keyword matching to identify common words that can indicate a relationship between a communication and a calendar event. In various embodiments, the relevance is determined based any of: an identity of a sender of the one or more unread or unanswered communications, an identity of an organizer or required participant of the calendar event, a comparison of a topic of the calendar event to a title of the one or more unread or unanswered communications, a matching keyword that is present in both the one or more unread or unanswered communications and an description or title of the calendar event, and/or other matching details between a communication and a calendar event. Thus, for example, if an identity of the sender of an unread communication matches the identity of the host or a required participant of a meeting, the unread communication may be determined to be relevant to that meeting. Relevance can be scored based on a degree of match, with relevance values increasing when there are more matches present between a communication and an upcoming calendar event. For example, if an identity of a sender of an email matches the identity of the meeting host, and the title of the meeting matches the title of the email, then the relevance score for the email with respect to the meeting will be higher than if only the identity of the sender and meeting host matched. Matching keywords can be identified using any natural language processing techniques, including performing stemming or lemmatization prior to identifying matching, performing synonym matching, and the like.

In some embodiments, relevance is determined using a trained natural language processing or machine learning model. A predictive model can be trained using a training corpus that includes examples of calendar event data and corresponding communications that are each labeled with regard to relevance. For example, the labels may include a binary “relevant” or “not relevant,” or the labels may include a degree of relevance (e.g., a value between one and ten). Thus, the predictive model can be trained to automatically analyze input calendar data and communications received by a user to score each communication by relevance. In other embodiments, an unsupervised machine learning model (e.g., a natural language processing model) can be used to determine the relevance score between a message and an event.

Priority analysis module 116 may sort unread and/or unanswered communications by their relevance and urgency scores in order to identify one or more communications that are high-priority. In some embodiments, the relevance and urgency scores are separately weighted before being combined in order to provide greater or lesser weight to one score category over another. Relevance and urgency scores can be combined in any desired mathematical manner, such as adding the scores, averaging the scores, and the like. In embodiments in which relevance and urgency are assessed over different ranges, the relevance and/or urgency scores may be normalized; for example, if relevance ranges from zero to five, and urgency ranges from zero to ten, a relevance score may be doubled before combining with an urgency score.

Once unread and/or unanswered communications are scored, then one or more high-priority communications can be selected by priority analysis module 116. In some embodiments, any unread and/or unanswered communication that surpasses a threshold score value may be identified as having high priority. In some embodiments, unread and/or unanswered communications may be sorted according to their scores, and a highest N number of communications may be selected as high-priority communications. For example, the highest-scored communication may be selected, or the top three communications may be selected. Once a communication is determined to be a high-priority communication, priority analysis module 116 may transmit instructions to communication module 112 to cause the user to be alerted to the high-priority communication.

Meeting client module 118 is a client that enables users to participate in virtual meetings through their computing devices (e.g., user device 102). Once connected to a server (e.g., collaboration server 120), meeting client module 118 facilitates the exchange of data between users, including audio data, video data, text data, and other data (e.g., documents being presented during a meeting). Thus, users can virtually collaborate by talking to each other and/or viewing each other in real-time, as well as record meetings, share documents, and perform other desired tasks.

Collaboration server 120 includes a network interface (I/F) 122, at least one processor 124, and memory 126, which stores instructions for a meeting host module 128. In various embodiments, collaboration server 120 may include a rack-mounted server, laptop, desktop, smartphone, tablet, or any other programmable electronic device capable of executing computer readable program instructions. Network interface 122 enables components of collaboration server 120 to send and receive data over a network, such as network 140. In general, collaboration server 120 hosts collaboration sessions by facilitating the exchange of data, including media content (e.g., user video data and/or audio data) that is exchanged during collaboration sessions.

Meeting host module 128 may include one or more modules or units to perform various functions of the embodiments described below. Meeting host module 128 may be implemented by any combination of any quantity of software and/or hardware modules or units, and may reside within memory 126 of collaboration server 120 for execution by a processor, such as processor 124. Meeting host module 128 may host collaboration sessions by facilitating the exchange of data between client devices (e.g., user device 102) via their client modules (e.g., meeting client module 118). The collaboration sessions may include video data (e.g., data gathered by a camera), audio data (e.g., data gathered by a microphone), and/or other forms of data (e.g., text, graphical data, slideshows, etc.). In some embodiments, a user may initiate or join a meeting by activating a calendar event that is presented by calendar client module 114 of user device 102.

Calendar server 130 includes a network interface (I/F) 132, at least one processor 134, and memory 136, which stores instructions for a calendar module 138. In various embodiments, calendar server 130 may include a rack-mounted server, laptop, desktop, smartphone, tablet, or any other programmable electronic device capable of executing computer readable program instructions. Network interface 132 enables components of calendar server 130 to send and receive data over a network, such as network 140. In general, calendar server 130 enables users to manage and synchronize calendar event data across multiple devices and/or with other users.

Calendar module 138 may include one or more modules or units to perform various functions of the embodiments described below. Calendar module 138 may be implemented by any combination of any quantity of software and/or hardware modules or units, and may reside within memory 136 of calendar server 130 for execution by a processor, such as processor 134. Calendar module 138 may enable users to store and manage their schedules, appointments, or other events on a server (e.g., calendar server 130), which can then be accessed from a variety of different client devices and/or applications. Calendar module 138 thus enables the scheduling and managing of appointments across multiple users and devices. Calendar module 138 may maintain a database that stores appointment information, and components that authenticate and authorize particular users to access particular calendar data. Once a user is authenticated with a calendar, the user may create, modify, and/or delete appointments.

Network 140 may include a local area network (LAN), a wide area network (WAN) such as the Internet, or a combination of the two, and includes wired, wireless, or fiber optic connections. In general, network 140 can be any combination of connections and protocols known in the art that will support communications between user device 102, collaboration server 120, and/or calendar server 130 via their respective network interfaces in accordance with the described embodiments.

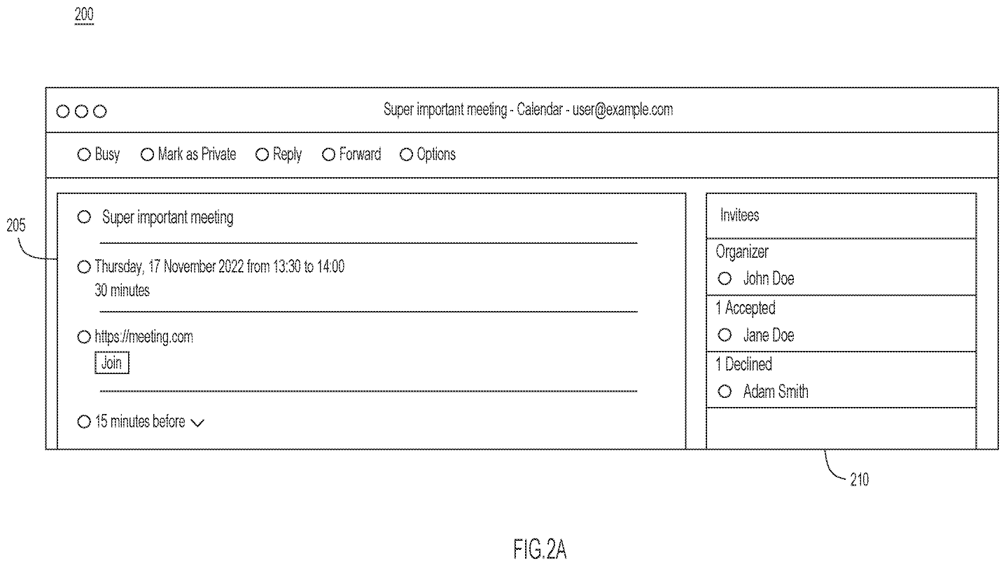

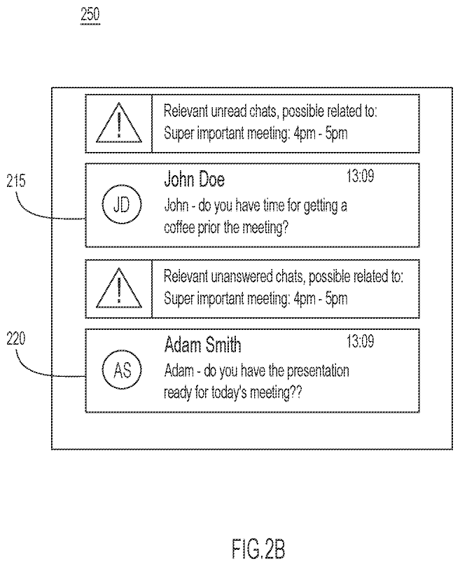

With reference now to FIG. 2A, a diagram is shown of a graphical user interface 200 for presenting an alert to a user, according to an example embodiment. Graphical user interface 200 depicts calendar event data that includes a meeting topic and time 205, and invitee data 210. Thus, graphical user interface 200 may correspond to a user interface for a calendar application, and presents at least some of the data that is analyzed in combination with communication data to identify high-priority communications.

With reference now to FIG. 2B, a diagram is shown of a graphical user interface 250 for presenting an alert to a user, according to an example embodiment. Graphical user interface 250 depicts alerts 215 and 220, which are graphically presented to a user as reminders for the user. As depicted, alert 215 indicates that the user has an unread chat that is related to an upcoming meeting, and alert 220 indicates that the user has a read but unanswered chat that is related to an upcoming meeting. Alerts can be presented in any manner in order to gain a user's attention, such as overlaying the alert window over other windows, flashing the alert window, presenting the alert window using a high-visibility user interface element, such as a particular color (e.g., red, orange, green, yellow, etc.) or a different color from the rest of a user interface's color scheme, or presenting the alert using any other graphical indicator. Additionally, the alert can be accompanied by a sound notification, haptic feedback, and the like. In some embodiments, the alert is presented by changing an order in which messages are presented to the user to make the unread or unanswered communication more readily visible. For example, if an inbox is sorted by email receipt time, an unread or unanswered email that is high-priority may be moved to the top of the list temporarily so that the user's attention is drawn to the email. In some embodiments, the high-priority communication is pinned to the top of a list until the user reads or answers the communication or until the related meeting has begun or is completed.

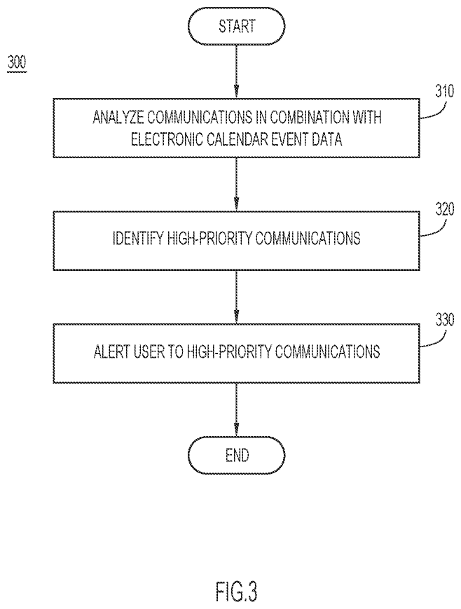

FIG. 3 is a flow chart of a method 300 of alerting a user to high-priority communications, according to an example embodiment.

Communications are analyzed in combination with electronic calendar event data at operation 310. Initially, unread and/or unanswered communications that are received by a user account may be obtained. These communications may include text-based communications such as emails, text messages, chat messages, a missed telephone call, transcribed voicemails, or any other form of message. Additionally, calendar event data may be obtained from a user's electronic calendar, including a meeting time, location, title, description, identity of host, identities of attendees, agenda, and any other relevant data. The communications are analyzed in combination with the electronic calendar data to score communications based on urgency and relevance to a meeting. Urgency may be determined based on the proximity of the meeting by comparing the current time to the meeting's scheduled time.

In various embodiments, the relevance of a communication can be determined based on one or more of: an identity of a sender of the one or more unread or unanswered communications, an identity of an organizer or required participant of the calendar event, a comparison of a topic of the calendar event to a title of the one or more unread or unanswered communications, and/or a matching keyword that is present in both the one or more unread or unanswered communications and an description or title of the calendar event. For a missed telephone call, the identity of the caller can be compared to participant or host identities in the calendar event data. Relevance can also be determined using a trained natural language processing model to identify words or phrases in a communication that are likely to relate to a particular calendar event. In particular, a trained machine learning model may identify relevance based on a semantic understanding of each communication's content. In some embodiments, each communication is assigned a relevance score and an urgency score, which can be combined to provide an overall priority score for each communication.

One or more high-priority communications are identified at operation 320. The one or more high-priority communications may be selected based on their urgency score, relevance score, and/or priority score. In some embodiments, the one or more high-priority communications are identified based on their priority score exceeding a predetermined threshold value.

The user is alerted to the one or more high-priority communications at operation 330. An alert notification may be presented to the user via one or more computing devices (e.g., user device 102). In various embodiments, the alert may include a visual alert (e.g., presented using a graphical user interface), an audio alert, and/or a haptic alert. The alert that is selected may be different from other modes of alerting a user to various events in order to draw the user's attention. In some embodiments, the alert is timed based on content in the communication, which can be determined using a natural language understanding model. In particular, a model may process the communication to determine an estimated time to complete a task, and tasks that are determined to take longer (e.g., “prepare a report”) may cause the alert to be sent to the user when the meeting time is farther away (e.g., one week away), whereas tasks that are determined to take require less user time (e.g., “send an email”) may cause the alert to be delayed until closer to the meeting time (e.g., one hour before the meeting).

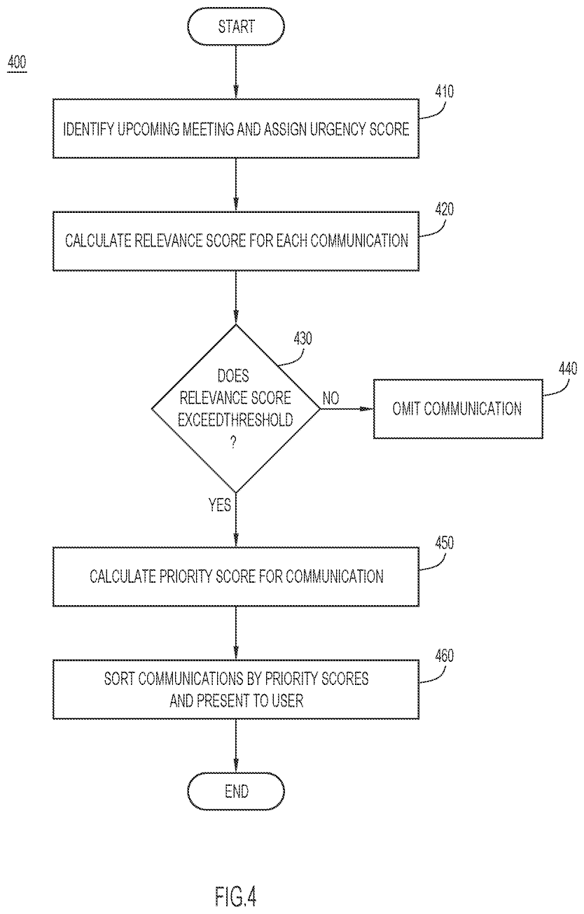

FIG. 4 is a flow chart of a method 400 of identifying high-priority communications, according to an example embodiment.

An upcoming meeting is identified and assigned an urgency score at operation 410. User calendar data may be analyzed to identify one or more upcoming meetings. In some embodiments, a future time constraint window may limit how much of a user's calendar data is analyzed (e.g., a next hour, a next day, a next week, etc.). The urgency of an identified calendar event is determined based on the scheduled time for the calendar event in view of the current time. Thus, a meeting that is close in temporal proximity may be assigned an urgency score that reflects that the meeting is highly urgent. Thus, as a meeting approaches, the urgency score increases.

A relevance score is calculated for each communication at operation 420. Unread and/or unanswered communications are analyzed to calculate a relevance score for each communication in view of the identified upcoming meeting(s). In various embodiments, the relevance score may be computed using assigned values that are determined based on a topic match between the communication and the calendar event, a participant match between a communication sender and the calendar event, key word detection, and/or any other details indicative of relevance. Based on the closeness and number of matching details, a relevance score may be assigned that indicates a particular degree of relevance for each communication.

Operation 430 determines whether the relevance score exceeds a threshold. If a communication's relevance score exceeds the threshold, then the priority score for each communication is calculated at operation 450. Otherwise the communication is omitted from further consideration at operation 440. In various embodiments, the threshold may be a static threshold value, a different threshold value can be used for each user (including a user-defined threshold value), or the threshold value can be dynamically calculated. The threshold value can be dynamically calculated based on an event's importance, which can be determined based on metadata (e.g., a “high-importance” flag), based on the presence of particular keywords or participants, and/or using natural language processing (e.g., applying tone analysis to a meeting's description). For example, the threshold value may be lowered for an important event to increase the likelihood that a given communication is determined to be a high-priority communication.

The priority score for each communication is calculated at operation 450 by combining the relevance score and urgency score of the communication, which may be separately weighted to adjust the influence of each score over the resulting priority score.

The communications are sorted by priority scores and presented to a user at operation 460. The sorting operation causes communications that are deemed to be highest in priority to be presented to the user. In some embodiments, a select number of highest-priority communications are presented to the user, such as the communication that is highest in priority overall, or a top three highest-priority communications.

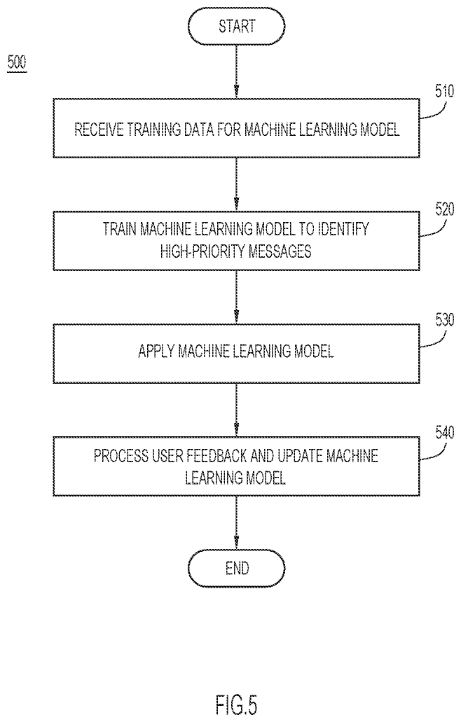

FIG. 5 is a flow chart of a method 500 of training and applying a machine learning model, according to an example embodiment.

Training data for a machine learning model is received at operation 510. The training data may include a plurality of examples of communications that are each paired with another example of calendar event data, in which each communication is labeled with a relevance score for the corresponding calendar event data. For example, one example communication may be assigned a relevance score of 0.7 out of 1.0 to indicate that the example communication is rather relevant to a calendar event, whereas a less-relevant example communication may receive a relevance score of 0.2, and a completely irrelevant communication may receive a relevance score of zero. In some embodiments, a Large Language Model (LLM) may be employed in combination with a one-shot learning approach in order to provide a model that not require pre-training to determine relevance scores.

The machine learning model is trained to identify high-priority messages at operation 520. Training may be performed using the training data, a subset of which may be used for testing the machine learning model until the machine learning model achieves a desired level of accuracy. The machine learning model is applied at operation 530 by providing user communications and calendar event data to the machine learning model, which then scores each communication by outputting a relevance score.

The machine learning model is updated by processing user feedback at operation 540. A user may provide feedback that indicates whether a communication to which the user was alerted was actually relevant or not. If a communication was relevant, then the communication may be added to the training data (along with the corresponding calendar data) and labeled with the communication's relevance score, which may be adjusted to indicate that the meeting was relevant (e.g., increased in the case of a higher score indicating higher relevance, etc.). Similarly, if a communication is indicated by the user as not relevant, that communication can likewise be added to the training data along with the communication's relevance score, which may be adjusted to indicate that the communication was not indeed relevant. Additionally or alternatively, the user's action(s) may be used to update the model. In particular, if a user takes action, then the communication may be considered relevant, and the model may be updated accordingly, whereas user inaction may indicate that the communication was not relevant. In some embodiments, the response time of a user's action may further be used as an indicator of relevance, as a rapid response to a communication may indicate that the communication was more relevant than a slower user response. Thus, the machine learning model may be adjusted over time with actual user feedback to increase the accuracy of the machine learning model.

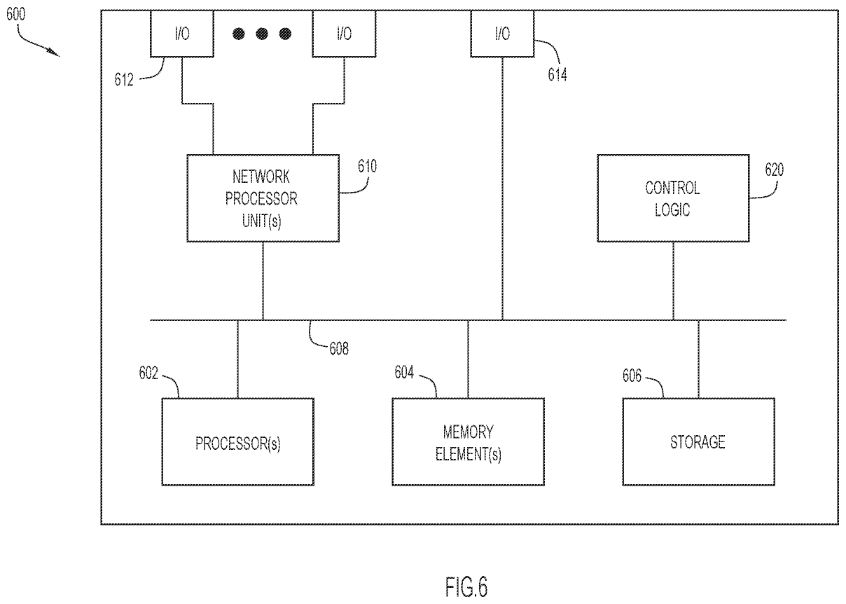

Referring now to FIG. 6, FIG. 6 illustrates a hardware block diagram of a computing device 600 that may perform functions associated with operations discussed herein in connection with the techniques depicted in FIGS. 1-5. In at least one embodiment, the computing device 600 may include one or more processor(s) 602, one or more memory element(s) 604, storage 606, a bus 608, one or more network processor unit(s) 610 interconnected with one or more network input/output (I/O) interface(s) 612, one or more I/O 614, and 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., 620) can, in various embodiments, be stored for computing device 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O 614 allow for input and output of data and/or information with other entities that may be connected to computing device 600. For example, I/O 614 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method for prioritizing communications relating to a meeting including: analyzing one or more unread or unanswered communications received by a user with respect to a plurality of calendar events of the user; identifying one or more high-priority communications in the one or more unread or unanswered communications that relate to a particular calendar event of the plurality of calendar events, based on relevance and urgency with respect to the particular calendar event; and transmitting instructions to a user device of the user to cause the user device to present an alert to the user regarding the one or more high-priority communications.

In some aspects, the techniques described herein relate to a method, further including determining the urgency based on a difference between a scheduled time of the particular calendar event and a current time.

In some aspects, the techniques described herein relate to a method, further including determining the relevance based on one or more of: an identity of a sender of the one or more unread or unanswered communications, an identity of an organizer or required participant of the particular calendar event, a comparison of a topic of the particular calendar event to a title of the one or more unread or unanswered communications, and a matching keyword that is present in both the one or more unread or unanswered communications and an description or title of the particular calendar event.

In some aspects, the techniques described herein relate to a method, wherein identifying includes analyzing, with a machine learning model, the one or more unread or unanswered communications with respect to the particular calendar event to identify the one or more high-priority communications based on relevance.

In some aspects, the techniques described herein relate to a method, wherein the one or more unread or unanswered communications include one or more of: a missed telephone call, a transcribed voicemail call, an e-mail, a short messaging service message, and a chat message.

In some aspects, the techniques described herein relate to a method, wherein identifying includes identifying the one or more high-priority communications based on a priority value of each of the one or more unread or unanswered communications, and wherein the priority value is determined by separately-weighted relevance values and urgency values for each of the one or more unread or unanswered communications.

In some aspects, the techniques described herein relate to a method, wherein the instructions transmitted to the user device cause the alert to be presented by modifying an order in which the one or more unread or unanswered communications to prioritize the one or more high-priority communications.

In some aspects, the techniques described herein relate to a method, wherein the instructions transmitted to the user device cause the alert to be presented by performing one or more of: providing an audio alert, providing a haptic alert, and displaying the one or more high-priority communications in a high-visibility user interface element of the user device, wherein the high-visibility user interface element is a different color than other user interface elements or the high-visibility user interface element overlays the other user interface elements.

In some aspects, the techniques described herein relate to a system including: one or more computer processors; one or more computer readable storage media; and program instructions stored on the one or more computer readable storage media for execution by at least one of the one or more computer processors, the program instructions including instructions to: analyze one or more unread or unanswered communications received by a user with respect to a plurality of calendar events of the user; identify one or more high-priority communications in the one or more unread or unanswered communications that relate to a particular calendar event of the plurality of calendar events, based on relevance and urgency with respect to the particular calendar event; and transmit instructions to a user device of the user to cause the user device to present an alert to the user regarding the one or more high-priority communications.

In some aspects, the techniques described herein relate to a system, wherein the program instructions further include instructions to determine the urgency based on a difference between a scheduled time of the particular calendar event and a current time.

In some aspects, the techniques described herein relate to a system, wherein the program instructions further include instructions to determine the relevance based on one or more of: an identity of a sender of the one or more unread or unanswered communications, an identity of an organizer or required participant of the particular calendar event, a comparison of a topic of the particular calendar event to a title of the one or more unread or unanswered communications, and a matching keyword that is present in both the one or more unread or unanswered communications and an description or title of the particular calendar event.

In some aspects, the techniques described herein relate to a system, wherein the instructions to identify includes instructions to analyze, with a machine learning model, the one or more unread or unanswered communications with respect to the particular calendar event to identify the one or more high-priority communications based on relevance.

In some aspects, the techniques described herein relate to a system, wherein the one or more unread or unanswered communications include one or more of: a missed telephone call, a transcribed voicemail call, an e-mail, a short messaging service message, and a chat message.

In some aspects, the techniques described herein relate to a system, wherein identifying includes identifying the one or more high-priority communications based on a priority value of each of the one or more unread or unanswered communications, and wherein the priority value is determined by separately-weighted relevance values and urgency values for each of the one or more unread or unanswered communications.

In some aspects, the techniques described herein relate to a system, wherein the instructions transmitted to the user device cause the alert to be presented by modifying an order in which the one or more unread or unanswered communications to prioritize the one or more high-priority communications.

In some aspects, the techniques described herein relate to a system, wherein the instructions transmitted to the user device cause the alert to be presented by performing one or more of: providing an audio alert, providing a haptic alert, and displaying the one or more high-priority communications in a high-visibility user interface element of the user device, wherein the high-visibility user interface element is a different color than other user interface elements or the high-visibility user interface element overlays the other user interface elements.

In some aspects, the techniques described herein relate to one or more non-transitory computer readable storage media having program instructions embodied therewith, the program instructions executable by a computer to cause the computer to perform operations including: analyze one or more unread or unanswered communications received by a user with respect to a plurality of calendar events of the user; identify one or more high-priority communications in the one or more unread or unanswered communications that relate to a particular calendar event of the plurality of calendar events, based on relevance and urgency with respect to the particular calendar event; and transmit instructions to a user device of the user to cause the user device to present an alert to the user regarding the one or more high-priority communications.

In some aspects, the techniques described herein relate to one or more non-transitory computer readable storage media, wherein the program instructions further cause the computer to determine the urgency based on a difference between a scheduled time of the particular calendar event and a current time.

In some aspects, the techniques described herein relate to one or more non-transitory computer readable storage media, wherein the program instructions further cause the computer to determine the relevance based on one or more of: an identity of a sender of the one or more unread or unanswered communications, an identity of an organizer or required participant of the particular calendar event, a comparison of a topic of the particular calendar event to a title of the one or more unread or unanswered communications, and a matching keyword that is present in both the one or more unread or unanswered communications and an description or title of the particular calendar event.

In some aspects, the techniques described herein relate to one or more non-transitory computer readable storage media, wherein the instructions to identify cause the computer to analyze, with a machine learning model, the one or more unread or unanswered communications with respect to the particular calendar event to identify the one or more high-priority communications based on relevance.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method for prioritizing communications relating to a meeting comprising:
analyzing one or more unread or unanswered communications received by a user with respect to a plurality of calendar events of the user;
identifying one or more high-priority communications in the one or more unread or unanswered communications that relate to a particular calendar event of the plurality of calendar events, based on relevance and urgency with respect to the particular calendar event; and
transmitting instructions to a user device of the user to cause the user device to present an alert to the user regarding the one or more high-priority communications.

2. The method of claim 1, further comprising determining the urgency based on a difference between a scheduled time of the particular calendar event and a current time.

3. The method of claim 1, further comprising determining the relevance based on one or more of: an identity of a sender of the one or more unread or unanswered communications, an identity of an organizer or required participant of the particular calendar event, a comparison of a topic of the particular calendar event to a title of the one or more unread or unanswered communications, and a matching keyword that is present in both the one or more unread or unanswered communications and an description or title of the particular calendar event.

4. The method of claim 1, wherein identifying comprises analyzing, with a machine learning model, the one or more unread or unanswered communications with respect to the particular calendar event to identify the one or more high-priority communications based on relevance.

5. The method of claim 1, wherein the one or more unread or unanswered communications comprise one or more of: a missed telephone call, a transcribed voicemail call, an e-mail, a short messaging service message, and a chat message.

6. The method of claim 1, wherein identifying comprises identifying the one or more high-priority communications based on a priority value of each of the one or more unread or unanswered communications, and wherein the priority value is determined by separately-weighted relevance values and urgency values for each of the one or more unread or unanswered communications.

7. The method of claim 1, wherein the instructions transmitted to the user device cause the alert to be presented by modifying an order in which the one or more unread or unanswered communications to prioritize the one or more high-priority communications.

8. The method of claim 1, wherein the instructions transmitted to the user device cause the alert to be presented by performing one or more of: providing an audio alert, providing a haptic alert, and displaying the one or more high-priority communications in a high-visibility user interface element of the user device, wherein the high-visibility user interface element is a different color than other user interface elements or the high-visibility user interface element overlays the other user interface elements.

9. A system comprising:
one or more computer processors;
one or more computer readable storage media; and
program instructions stored on the one or more computer readable storage media for execution by at least one of the one or more computer processors, the program instructions comprising instructions to:
analyze one or more unread or unanswered communications received by a user with respect to a plurality of calendar events of the user;
identify one or more high-priority communications in the one or more unread or unanswered communications that relate to a particular calendar event of the plurality of calendar events, based on relevance and urgency with respect to the particular calendar event; and
transmit instructions to a user device of the user to cause the user device to present an alert to the user regarding the one or more high-priority communications.

10. The system of claim 9, wherein the program instructions further comprise instructions to determine the urgency based on a difference between a scheduled time of the particular calendar event and a current time.

11. The system of claim 9, wherein the program instructions further comprise instructions to determine the relevance based on one or more of: an identity of a sender of the one or more unread or unanswered communications, an identity of an organizer or required participant of the particular calendar event, a comparison of a topic of the particular calendar event to a title of the one or more unread or unanswered communications, and a matching keyword that is present in both the one or more unread or unanswered communications and an description or title of the particular calendar event.

12. The system of claim 9, wherein the instructions to identify comprises instructions to analyze, with a machine learning model, the one or more unread or unanswered communications with respect to the particular calendar event to identify the one or more high-priority communications based on relevance.

13. The system of claim 9, wherein the one or more unread or unanswered communications comprise one or more of: a missed telephone call, a transcribed voicemail call, an e-mail, a short messaging service message, and a chat message.

14. The system of claim 9, wherein identifying comprises identifying the one or more high-priority communications based on a priority value of each of the one or more unread or unanswered communications, and wherein the priority value is determined by separately-weighted relevance values and urgency values for each of the one or more unread or unanswered communications.

15. The system of claim 9, wherein the instructions transmitted to the user device cause the alert to be presented by modifying an order in which the one or more unread or unanswered communications to prioritize the one or more high-priority communications.

16. The system of claim 9, wherein the instructions transmitted to the user device cause the alert to be presented by performing one or more of: providing an audio alert, providing a haptic alert, and displaying the one or more high-priority communications in a high-visibility user interface element of the user device, wherein the high-visibility user interface element is a different color than other user interface elements or the high-visibility user interface element overlays the other user interface elements.

17. One or more non-transitory computer readable storage media having program instructions embodied therewith, the program instructions executable by a computer to cause the computer to perform operations including:
analyze one or more unread or unanswered communications received by a user with respect to a plurality of calendar events of the user;
identify one or more high-priority communications in the one or more unread or unanswered communications that relate to a particular calendar event of the plurality of calendar events, based on relevance and urgency with respect to the particular calendar event; and
transmit instructions to a user device of the user to cause the user device to present an alert to the user regarding the one or more high-priority communications.

18. The one or more non-transitory computer readable storage media of claim 17, wherein the program instructions further cause the computer to determine the urgency based on a difference between a scheduled time of the particular calendar event and a current time.

19. The one or more non-transitory computer readable storage media of claim 17, wherein the program instructions further cause the computer to determine the relevance based on one or more of: an identity of a sender of the one or more unread or unanswered communications, an identity of an organizer or required participant of the particular calendar event, a comparison of a topic of the particular calendar event to a title of the one or more unread or unanswered communications, and a matching keyword that is present in both the one or more unread or unanswered communications and an description or title of the particular calendar event.

20. The one or more non-transitory computer readable storage media of claim 17, wherein the instructions to identify cause the computer to analyze, with a machine learning model, the one or more unread or unanswered communications with respect to the particular calendar event to identify the one or more high-priority communications based on relevance.
